(19) United States
(12) Patent Application Publication
(10) Pub. No.: US 2019/0123364 A1
(43) Pub. Date: Apr. 25, 2019

(54) FUEL CELL HAVING AN INTEGRATED WATER VAPOR TRANSFER REGION

(71) Applicant: GM GLOBAL TECHNOLOGY OPERATIONS LLC, DETROIT, MI (US)

(72) Inventors: Mark F Mathias, Rochester Hills, MI (US); Balasubramanian Lakshmanan, Rochester Hills, MI (US); Wenbin Gu, Sterling Heights, MI (US)

(21) Appl. No.: 15/791,798

(22) Filed: Oct. 24, 2017

(51) Int. Cl. H01M 8/04119; H01M 8/1004; H01M 8/0202; H01M 8/04291

(52) U.S. Cl. CPC H01M 8/04141; H01M 8/1004; H01M 2250/10; H01M 8/04291; H01M 2250/20; H01M 8/0202

(57) ABSTRACT

The present disclosure provides an integrated fuel cell having a water vapor transfer region wherein the integrated fuel cell includes a first bipolar plate, a second bipolar plate, and a membrane electrode assembly (MEA) disposed between the first and second bipolar plates. The membrane electrode assembly further includes a water vapor transfer portion and at least one active area portion configured to generate electricity and provide a water byproduct upon facilitating a reaction involving an input stream containing hydrogen and an input stream containing oxygen.

### TECHNICAL FIELD

The invention relates to an improved fuel cell and fuel cell stack having a water vapor transfer region integrated in each fuel cell.

### BACKGROUND

Fuel cell systems are used as a power source for electric vehicles, stationary power supplies, and other applications. One known fuel cell stack system is the proton exchange membrane (PEM) fuel cell stack system that includes a membrane electrode assembly (MEA) comprising a thin, solid polymer membrane-electrolyte having an anode on one face and a cathode on the opposite face. The MEA is sandwiched between a pair of electrically conductive contact elements which serve as current collectors for the anode and cathode, which may contain appropriate channels and openings therein for distributing the fuel cell stack system's gaseous reactants (i.e., H2 and O2 or air) over the surfaces of the respective anode and cathode.

PEM fuel cells comprise a plurality of the MEAs stacked together in electrical series while being separated by an impermeable, electrically conductive contact element known as a bipolar plate or current collector. The fuel cell stack systems are operated in a manner that maintains the MEAs in a humidified state. The level of humidity of the MEAs affects the performance of the fuel cell stack system. Additionally, if an MEA is operated too dry, the useful life of the MEA can be reduced. To avoid drying out the MEAs, the typical fuel cell stack systems are operated with the MEA at a desired humidity level, wherein liquid water is formed in the fuel cell during the production of electricity. Additionally, the cathode and anode reactant gases being supplied to the fuel cell stack system are also humidified to prevent the drying of the MEAs in the locations proximate the inlets for the reactant gases. Traditionally, a water vapor transfer (WVT) unit is utilized to humidify the cathode reactant gas prior to entering into the fuel cell. See, for example, U.S. Pat. No. 7,138,197 by Forte et al., incorporated herein by referenced in its entirety, a method of operating a fuel cell stack system.

The basic components of a PEM-type fuel cell are two electrodes separated by a polymer membrane electrolyte. Each electrode is positioned on opposite sides of the membrane as a thin catalyst layer. Similarly, on each side of the assembly adjacent to each thin catalyst layer, a microporous layer and a gas diffusion layer is provided. The gas diffusion layer being the outermost layer on each side of the membrane electrode assembly (MEA). The gas diffusion layer (GDL) is commonly composed of non-woven carbon fiber paper or woven carbon cloth. The GDL is primarily provided to enable conductivity, and to help gases to come in contact with the catalyst. The GDL works as a support for the catalyst layer, provides good mechanical strength and easy gas access to the catalyst and improves the electrical conductivity. The purpose of the microporous layer is to minimize the contact resistance between the GDL and catalyst layer, limit the loss of catalyst to the GDL interior and help to improve water management as it provides effective water transport. Accordingly, the electrodes (catalyst layer), membrane, microporous layers, and gas diffusion layer together form the membrane electrode assembly (MEA). The MEA is generally disposed between two bipolar plates to form a fuel cell arrangement.

As is known, hydrogen is supplied to the fuel cells in a fuel cell stack to cause the necessary chemical reaction to power the vehicle using electricity. One of the byproducts of this chemical reaction in a traditional fuel cell is water in the form of vapor and/or liquid. It is also desirable to provide humid air as an input to the fuel cell stack to maximize the performance output for a given fuel cell stack size. Humid air also prevents premature mechanical and chemical degradation of the fuel cell membrane.

The input air is typically supplied by a compressor while a water transfer device external to the stack is traditionally implemented in a fuel cell system to add moisture to the input air supplied by a compressor, the source of the moisture often coming from the product-water-laden stack cathode outlet stream. These components among many other components in a traditional fuel cell system contribute to the cost of the fuel cell system and also takes up packaging space. In many applications, such as but not limited to a vehicle, packaging space is limited.

Accordingly, there is a need to integrate components of a fuel cell system where possible at a reasonable cost.

### SUMMARY

In one embodiment of the present disclosure, a fuel cell with an integrated water transfer region is provided wherein the integrated fuel cell includes a first bipolar plate, a second bipolar plate, and a membrane electrode assembly (MEA) disposed between the first and second bipolar plates. The membrane electrode assembly further includes a water vapor transfer portion and a fuel cell active area portion. The water vapor portion is configured to transfer moisture while the active area portion includes two electrodes and is configured to generate electricity and provide a water byproduct upon facilitating a reaction involving an input stream with hydrogen and input airstream with oxygen.

In yet another embodiment of the present disclosure, an integrated fuel cell stack having a water transfer feature is provided wherein the integrated fuel cell stack includes a first end plate, a second end plate, and a plurality of fuel cells disposed between the first and second end plates. Each fuel cell in the plurality of fuel cells includes first and second bipolar plates with a membrane electrode assembly disposed between the first and second bipolar plates. The membrane electrode assembly further includes a water vapor transfer portion and a fuel cell active area portion configured to generate an electric current and provide a water byproduct upon facilitating a reaction involving a stream containing hydrogen and a stream containing oxygen. The water vapor transfer portion is configured to recirculate moisture generated within the fuel cell via a primary stream of fluid (such as but not limited to the anode stream including gaseous hydrogen from a tank) to a secondary stream of fluid (such as but not limited to charged air from a compressor). The water vapor transfer portion of the membrane electrode assembly for each fuel cell in the fuel cell stack may be hydrophilic relative to the active area portion.

In one embodiment, the water vapor transfer portion of the MEA for each fuel cell in the fuel cell stack may be defined at a first MEA end of the membrane electrode assembly (where the charged air from the compressor enters the fuel cell). The fuel cell active area portion may be defined at the second MEA end of the membrane electrode assembly. Alternatively, the water vapor transfer portion may be defined at both the first MEA end of the membrane electrode assembly as well as at a second MEA end of the membrane electrode assembly with the fuel cell active area portion defined between the water vapor transfer portions at the first and second MEA ends.

The moisture from the exhaust airstream is transferred to the input stream of hydrogen via the membrane of the water vapor transfer portion at the second MEA end. The first MEA end also defines a water vapor transfer portion where the moisture from the output stream of hydrogen is transferred to the charged input airstream from the compressor via the membrane of the water vapor transfer portion at the first MEA end. The design described above accomplishes efficient recycle of the water within the single integrated fuel-cell.

Each fuel cell in the fuel cell stack may also be in fluid communication with an anode loop which is configured to send water generated by the chemical reaction at the active area back to an anode inlet of the fuel cell proximate to the second MEA end. This recycle can be accomplished by, for example, a system including injectors and ejectors or including an anode recycle pump. The water entering the cell in the recycled hydrogen-containing stream can then transfer through a water vapor transfer portion to humidify the cathode inlet stream. It is particularly important to provide humidity to the cathode inlet stream prior to contacting the active fuel cell, since a dry air stream is known to cause membrane chemical degradation in the presence of fuel cell electrodes. This anode loop design and function may be implemented in the various embodiments of the present disclosure.

With respect to the embodiment of the integrated fuel cell stack, the water vapor transfer portion disposed at the first MEA end for a plurality of fuel cells in the fuel cell stack is configured to transfer moisture from the output gaseous hydrogen stream to the charged input airstream (at first MEA end) from the compressor. Moreover, the water vapor transfer portion disposed at the second MEA end of each fuel cell in the fuel cell stack may be configured to transfer moisture from the exhaust airstream into the input gaseous hydrogen stream (proximate to the second MEA end).

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is an example schematic diagram of one known fuel cell system.

FIG. 2 is a schematic diagram of a traditional water vapor transfer unit which is external to a fuel cell in a fuel cell stack.

FIG. 3 is a schematic diagram of an example side view of an expanded first embodiment integrated fuel cell in accordance with the present disclosure.

FIG. 4 is a schematic diagram of an example front view of a first embodiment fuel cell with the gas diffusion layer disposed onto a first bipolar plate.

FIG. 5 is a schematic front view of a second embodiment fuel cell with the integrated MEA disposed onto a first bipolar plate.

FIG. 6 is a schematic front view of a third embodiment fuel cell with the integrated MEA disposed onto a first bipolar plate.

FIG. 7 is a schematic diagram of an example feedback loop and water path in an integrated fuel cell of the present disclosure.

FIG. 8 is a schematic front view of an integrated fuel cell stack in accordance with various embodiments of the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

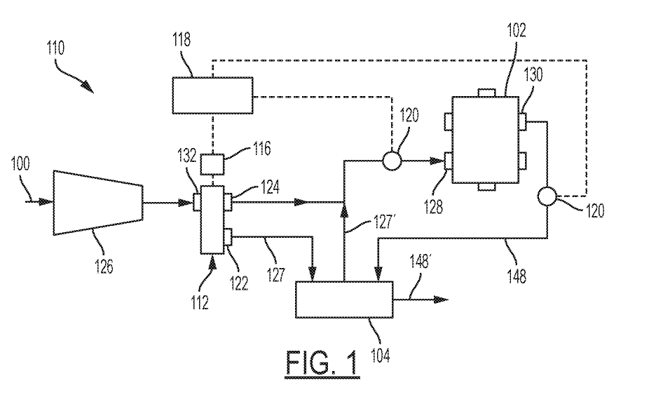

FIG. 1 shows a schematic cathode subsystem of a fuel cell system 110 known in the art. As shown, the typical water vapor transfer (WVT) device 104 is located away from a cathode outlet 130 and a cathode inlet 128 of the fuel cell stack of the fuel cell stack system. The traditional fuel cell system may, but not necessarily, include a charge air cooler and/or diverter 112 together with the water vapor transfer device 104 (such as a humidifier) to regulate a relative humidity of the fuel cell 102. The charge air cooler and/or diverter 112 may have the first inlet 132, the first outlet 124, and the second outlet 122. The traditional fuel cell system may further include the fuel cell 102 and an air compressor 126 as shown. The fuel cell 102 has a plurality of fuel cells, a cathode inlet 128, and a cathode outlet 130. The air compressor 126 is in fluid communication with the fuel cell 102 and adapted to provide a flow of charged air thereto. The WVT device 104 is generally an external component to the fuel cell stack and the WVT device 104 is in fluid communication with the air compressor 126 and the fuel cell 102 as shown. The WVT device 104 is adapted to selectively humidify the charged air provided to the fuel cell 102. The WVT device 104 may transfer moisture to the input charged air 127 (coming from the compressor 126) from the moist cathode exhaust stream 148 exiting the cathode outlet 130 via a membrane (not shown). Thus, the output charged air 127′ from the WVT device has sufficient humidity for use in the fuel cell 102. Other suitable means for humidifying the charged air may also be employed.

The optional charge air cooler (CAC and/or diverter) 112 is disposed in communication with the air compressor 126 and each of the fuel cell 102 and the WVT device 104. The first inlet 132 is in fluid communication with the air compressor 126. The first outlet 124 is in fluid communication with the fuel cell 102. The air compressor 126 draws in ambient air 100 and is in fluid communication with the WVT device 104 (via optional CAC and/or diverter 112). The second outlet 122 is in fluid communication with the WVT device 104. The charge air cooler (and/or three-way diverter) shown as element 112 is adapted to: a) cause charged air to bypass the WVT device 104 and flow to the fuel cell 102; and/or b) cause charged air to flow to the WVT device 104—to regulate the humidity of the fuel cell 102.

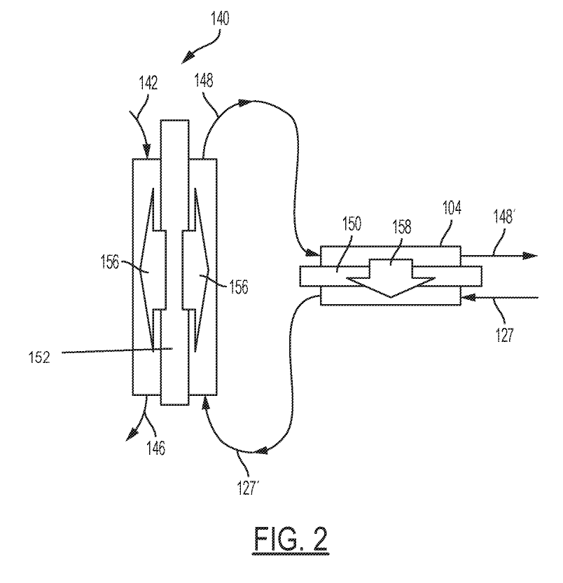

As shown in FIG. 2, a more detailed schematic of a traditional fuel cell and external water vapor transfer device. Input charged air 127 from the compressor 126 (and/or optionally CAC & Diverter 112) enters the WVT device 104. The WVT membrane 150 is configured to transfer moisture 158 from the moist cathode exhaust gas stream 148 thereby creating humidified output charged air 127′ to enter the fuel cell 140 at the cathode inlet 128 (see FIG. 1). The cathode exhaust stream 148 exits the fuel cell 102 as moisture rich air due to the water byproduct 156 from the reaction on the MEA 152 in the fuel cell 102. It is understood that after passing through the WVT device 104, the cathode exhaust stream 148′ has a reduced moisture content.

One example fuel system known in the art is illustrated in FIG. 1 may include the actuator 116, the controller 118, and at least one humidity sensor 120. The fuel cell system controller 118 may be in electrical communication with the actuator 116. The controller 118 regulates the humidity of the fuel cell 102 via actuator and/or WVT. A humidity sensor 120 may be provided in electrical communication with the controller in order to provide feedback of the charged air relative humidity to the controller 118. However, it is noted that more commonly known fuel systems eliminate the use of humidity sensors and instead use other means (e.g. the high frequency resistance of the stack) to indirectly measure the moisture in the system. Nonetheless, regardless of whether humidity sensors are implemented, many known fuel cell systems generally implement a WVT device 104 as shown which takes up space and increases the overall size of the fuel cell system. Packaging space for a fuel cell system can be particularly restrictive in applications such as, but not limited to vehicles. Thus, it is desirable to reduce the volume of such fuel cell systems especially in vehicle applications.

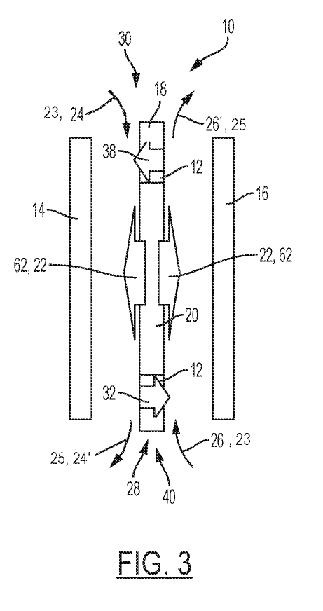

Accordingly, with reference to FIGS. 3-6, the present disclosure provides for a first embodiment of the present disclosure with an integrated fuel cell 10 having a WVT region which is internal to the fuel cell. The fuel cell 10 of the present disclosure includes a water transfer portion 12 which is integrated in the membrane electrode assembly 18. The integrated fuel cell 10 includes a first bipolar plate 14, a second bipolar plate 16, and a membrane electrode assembly (MEA) 18 disposed between the first and second bipolar plates 14, 16 as shown in FIG. 3. The membrane electrode assembly 18 further includes a water vapor transfer portion 12 and an active area portion 20. The water vapor portion 12 is configured to transfer moisture as described herein while the active area portion includes two electrodes and is configured to generate electricity 62 and provide a water byproduct 22 upon facilitating a reaction involving an input stream with hydrogen 24 and input airstream 26 with oxygen. It is understood that all references to input airstream 26 should be interpreted to mean that input airstream 26 contains oxygen.

The water vapor transfer portion 12 of the membrane electrode assembly 18 may be hydrophilic relative to the active area portion 20 and is operatively configured to transfer moisture from a primary stream 25 of fluid with higher relative humidity (such as but not limited output hydrogen stream 24′) to a secondary stream 23 of fluid (such as but not limited to a input charged air 26 at first MEA end 28). Alternatively, water vapor transfer portion 12 at the second MEA end 30 may be configured to also transfer moisture from a primary stream 25 of fluid (such as but not limited to exhaust airstream 26′) to a secondary stream 23 of fluid (such as but not limited to input gaseous stream with hydrogen 24). It is understood that the primary stream of fluid (exhaust airstream 26′ or output hydrogen stream 24′ or the like) is rich in moisture given that a water vapor byproduct results when the fuel cell generates electricity. The water vapor transfer portion may have one electrode or no electrodes in that particular region of the MEA.

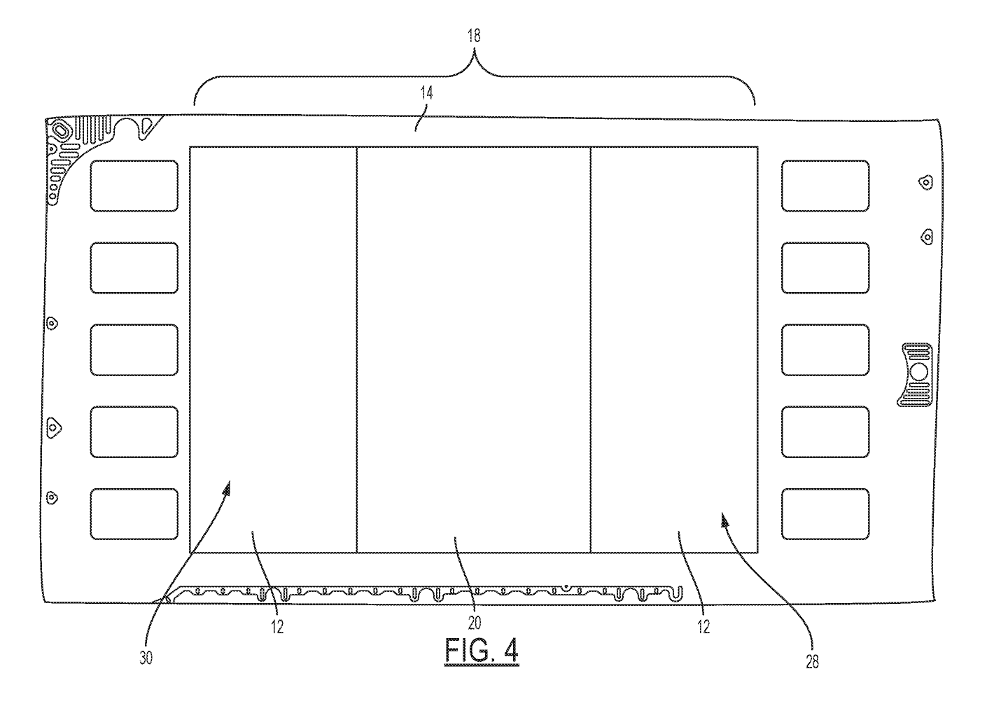

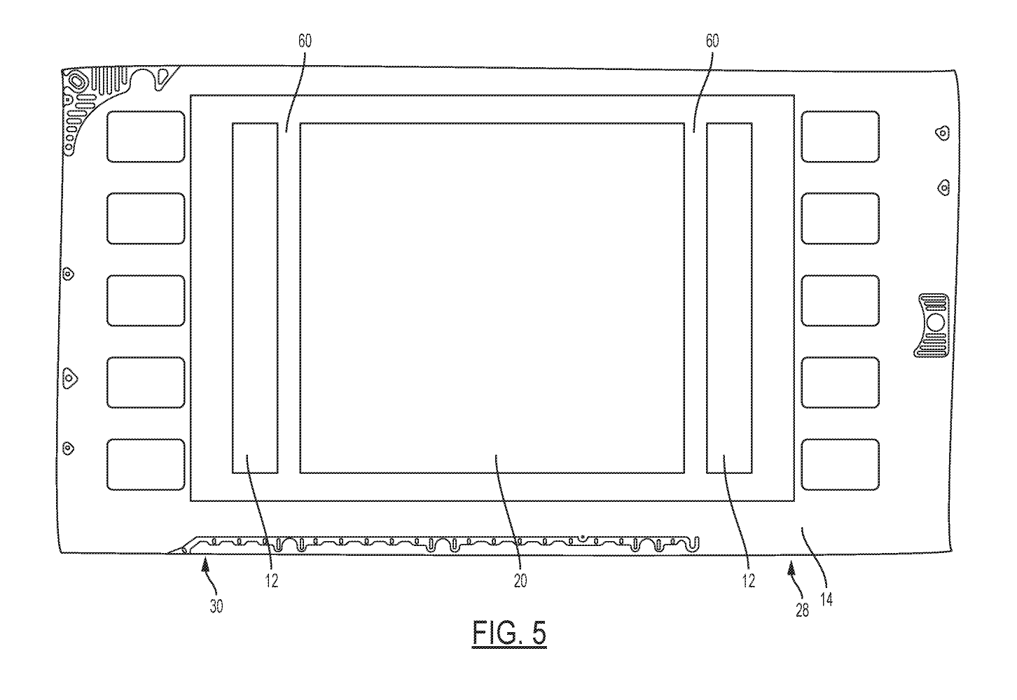

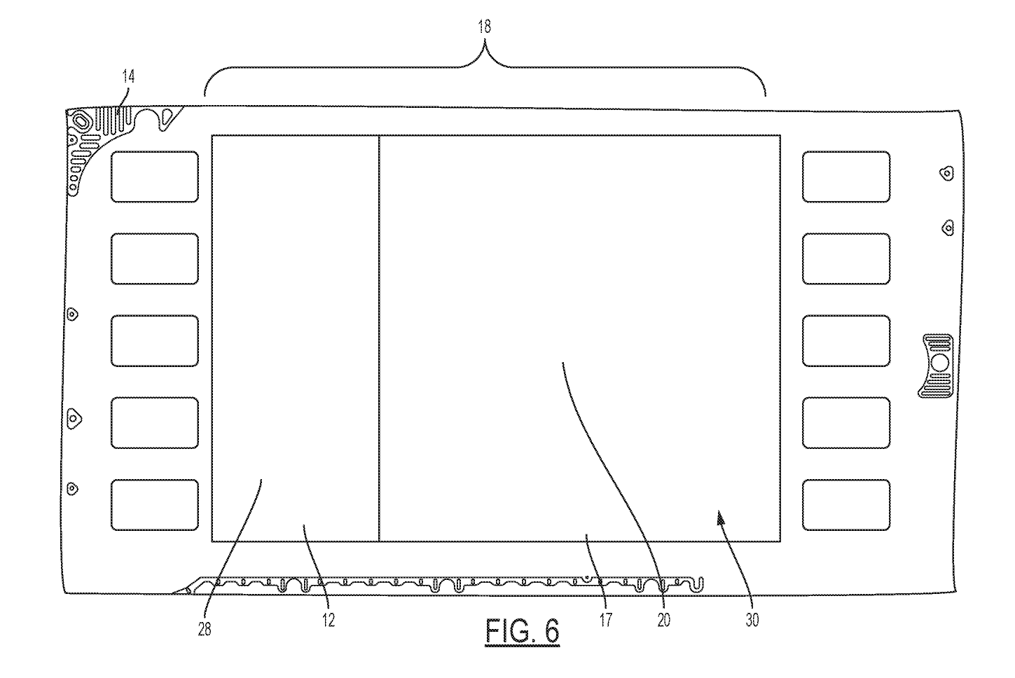

With reference to FIGS. 3-5, the water vapor transfer portion 12 may be defined at the first MEA end 28 of the membrane electrode assembly 18 and also at a second MEA end 30 of the membrane electrode assembly 18 with the active area portion 20 defined therebetween as specifically shown in FIG. 4. In FIG. 5, the water vapor transfer portion may be separate membrane(s) from the active area portion 20 as shown in non-limiting example FIG. 5 where a gasket 60 separates each region. Alternatively, with reference to FIG. 6, the water vapor transfer portion 12 of the MEA may be defined at a first MEA end 28 of the membrane electrode assembly 18 and the active area portion 20 may be defined in the middle region 17 and extend to the second MEA end 30 of the membrane electrode assembly 18. Nonetheless, it is understood with respect to all embodiments of the present disclosure, the water vapor transfer portion may either be integral to the active area portion (as shown in non-limiting examples FIGS. 3-4 and 6) or the water vapor transfer portion may be separate membrane(s) from the active area portion 20 as shown in non-limiting example FIG. 5 where a gasket 60 separates each region.

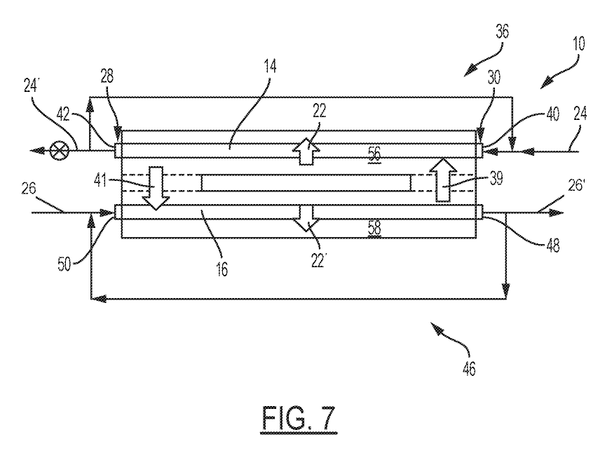

Referring to FIG. 7 and back to FIG. 3, it is understood that the input gaseous hydrogen stream 24 enters the fuel cell 10 proximate to the second MEA end 30, and an input charged airstream 26 with oxygen from the compressor (not shown) enters the fuel cell 10 proximate to the first MEA end 28 while a first water moisture/water stream 32 (FIG. 3) (see also element 41 in FIG. 7) extracted from the anode outlet 32 passes through the WVT region 12 proximate to the first MEA end 28 and a second moisture/water stream 38 (FIG. 3) (see also element 39 in FIG. 7) extracted from the cathode outlet 48 passes through the WVT region 12 proximate to the second MEA end 30 when the integrated fuel cell 10 is generating electricity/power 62 while simultaneously controlling the humidity levels in the fuel cell 10.

With respect to the integrated water vapor transfer portion(s), FIG. 3 shows that the water vapor transfer portion 12 disposed at the first MEA end 28 is configured to transfer moisture from a moisture rich primary stream (output hydrogen stream 24′) to input charged airstream 26 (secondary fluid) from the compressor (not shown) provided to the fuel cell 10 proximate to the first MEA end 28. Moreover, as shown in FIG. 3 only, the water vapor transfer portion 12 disposed at the second MEA end 30 may be configured to transfer moisture from primary stream (moisture rich exhaust airstream 26′) into the input stream with hydrogen 24 provided to the fuel cell 10 proximate to the second MEA end 30.

With reference now to FIG. 7, the fuel cell 10 may further include an anode loop 36 which is configured to send the water byproduct 22 (due to the chemical reaction at the active area portion 20) from the anode outlet 42 on the anode side 56 of the fuel cell 10 to the anode inlet 40 of the fuel cell 10 proximate to the second MEA end 30. However, an additional option of implementing a cathode loop 46 (in addition to the aforementioned anode loop 36) is provided where the cathode loop 46 is configured to send the water byproduct 22′ from the cathode side 58 of the fuel cell 10 from the cathode outlet 48 back to a cathode inlet 50 of the fuel cell 10 proximate to the first MEA end 28.

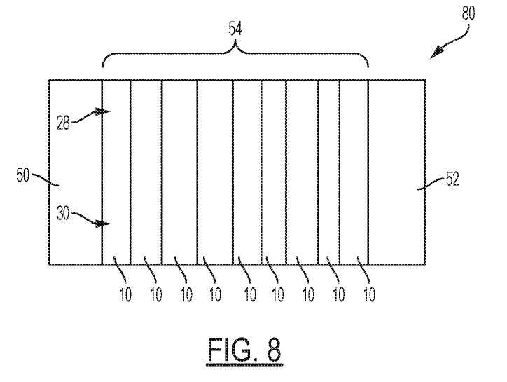

In yet another embodiment of the present disclosure, an integrated fuel cell stack 80 having a water vapor transfer feature is provided as shown in FIG. 8. The integrated fuel cell stack 80 includes a first end plate 50, a second end plate 52, and a plurality 54 of fuel cells 10 disposed between the first and second end plates. Each fuel cell 10 in the plurality 54 of fuel cells 10 is shown in greater detail in FIG. 3. Each fuel cell includes first and second bipolar plates 14, 16 with a membrane electrode assembly 18 disposed between the first and second bipolar plates 14, 16. The membrane electrode assembly 18 further includes a water vapor transfer portion 12 and an active area portion 20 (FIGS. 3-6) configured to generate an electric current and provide a water byproduct 22 (FIG. 3) upon facilitating a reaction involving an input stream with hydrogen 24 and input charged airstream 26. The water vapor transfer portion 12 is configured to transfer moisture from a moisture rich primary stream of fluid (such as output stream with hydrogen 24′ and/or exhaust airstream 26′) to a secondary stream of fluid (input charged air 26 and/or input stream with hydrogen 24 respectively). The primary stream of fluid may, but not necessarily, be the moisture rich output stream with hydrogen 24′ at the first MEA end, and/or exhaust airstream 26′ at the second MEA end (contained in the anode and cathode streams) while the secondary stream of fluid receiving the moisture may, but not necessarily, be an input stream with hydrogen 24 at the second MEA end and/or input charged airstream 26 at the first MEA end. Accordingly, it is understood that the primary stream 25 (FIG. 3) is the moisture rich stream that the WVT region transfers moisture away from while the secondary stream 23 (FIG. 3) is the relatively drier stream that the WVT region transfers moisture to. The water vapor transfer portion 12 of the membrane electrode assembly 18 for each fuel cell 10 in the fuel cell stack 80 may be hydrophilic relative to the active area portion 20.

With reference to FIG. 6, the water vapor transfer portion 12 of the MEA for each fuel cell 10 in the fuel cell stack 80 may be defined at a first MEA end 28 of the membrane electrode assembly 18 and the active area portion 20 may be defined at the middle region 17 extending to the second end 30 of the membrane electrode assembly. Alternatively, with reference to FIGS. 3, 4, and 5, the water vapor transfer portion 12 may be defined at the first MEA end 28 of the membrane electrode assembly 18 as well as at a second MEA end 30 of the membrane electrode assembly 18 with the active area portion 20 defined therebetween.

With reference to FIG. 3, for each fuel cell 10 in the fuel cell stack 80, an input stream with hydrogen 24 may enter the fuel cell 10 proximate to the second MEA end 30, and input charged air 26 from the compressor (not shown) may enter the fuel cell 10 proximate to the first MEA end 28 while a first water stream 41 (element 41 in FIG. 7) passes through the water vapor transfer membrane proximate to the first MEA end 28. Similarly, as shown in FIG. 7, a second water stream 39 passes through the water vapor transfer membrane 12 proximate to the second MEA end 30 when the integrated fuel cell 10 is generating electricity/power while simultaneously controlling the humidity levels in the fuel cell 10.

With reference again to FIG. 7, each fuel cell 10 in the fuel cell stack 80 may include an anode loop 36 which is configured to send the water byproduct 22 from the anode side 56 of the fuel cell from the anode outlet 42 back to the anode inlet 40 of the fuel cell 10 proximate to the second MEA end 30. Moreover, an additional option of implementing a cathode loop 46 (in addition to the aforementioned anode loop 36) is provided where the cathode loop 46 is configured to send the water byproduct 22′ from the cathode side 58 of the fuel cell 10 from the cathode outlet 48 back to the cathode inlet 50 of the fuel cell 10 proximate to the first MEA end 28. It is understood that input charged air 26 enters the fuel cell at the first MEA end or cathode inlet 50 of the fuel cell 10.

Referring now to FIGS. 3-6, the water vapor transfer portion 12 disposed at the first MEA end 28 for each fuel cell 10 in the integrated fuel cell stack 80 of the present disclosure is configured to transfer moisture from the primary fluid 25 to the secondary fluid 23 as described above. Moreover, as shown in FIGS. 3, 4 and 5, the water vapor transfer portion 12 disposed at the second MEA end 30 of each fuel cell 10 in the integrated fuel cell stack 80 may be configured to transfer moisture from the moisture rich exhaust airstream 26′ into the input stream with hydrogen 24 provided to the fuel cell 10 proximate to the second MEA end 30.

While at least two exemplary embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuel cell comprising:
a first bipolar plate;
a second bipolar plate;
and a membrane electrode assembly disposed between the first and second bipolar plate, the membrane electrode assembly having a water vapor transfer portion and an active area portion configured to generate electricity and provide a water byproduct upon facilitating a reaction involving an input stream containing hydrogen and an input stream containing oxygen.

2. The fuel cell as defined in claim 1 wherein the water vapor portion is configured to transfer moisture, and the active area portion includes two electrodes and is configured to generate electricity.

3. The fuel cell as defined in claim 2 wherein the water vapor transfer portion is defined at the first MEA end of the membrane electrode assembly and a second end of the membrane electrode assembly with the active area portion defined therebetween.

4. The fuel cell as defined in claim 2 wherein the water vapor transfer portion is defined at the first MEA end of the membrane electrode assembly and the active area portion is defined at a middle region extending to the second end of the membrane electrode assembly.

5. The fuel cell as defined in claim 3 wherein the input stream of hydrogen enters the fuel cell proximate to the second MEA end, and an input airstream containing oxygen enters the fuel cell proximate to the first MEA end while a first water stream passes through water vapor transfer region proximate to the first MEA end and a second water stream passes through the water vapor transfer region proximate to the second MEA end.

6. The fuel cell as defined in claim 2 wherein an anode loop of the fuel cell is configured to send the water byproduct from an anode side of the fuel cell back to a anode inlet of the fuel cell proximate to the second MEA end.

7. The fuel cell as defined in claim 6 wherein a cathode loop of the fuel cell is configured to send the water byproduct from a cathode side of the fuel cell back to an cathode inlet of the fuel cell proximate to the first MEA end.

8. The fuel cell as defined in claim 3 wherein the water vapor transfer portion disposed at the first MEA end is configured to transfer moisture from a primary stream to the input stream of charged air provided to the fuel cell proximate to the first MEA end.

9. A fuel cell stack comprising:
a first end plate;
a second end plate; and
a plurality of fuel cells disposed between the first and second end plates wherein each fuel cell in the plurality of fuel cells further includes;
a first bipolar plate;
a second bipolar plate;
and a membrane electrode assembly disposed between the first and second bipolar plates, the membrane electrode assembly having a water vapor transfer portion and an active area portion configured to generate an electric current and provide a water byproduct upon facilitating a reaction involving a stream containing hydrogen and a stream containing oxygen.

10. The fuel cell stack as defined in claim 9 wherein while the water vapor portion is configured to transfer moisture, and the active area portion includes two electrodes and is configured to generate electricity.

11. The fuel cell stack as defined in claim 10 wherein the water vapor transfer portion is defined at a first MEA end of the membrane electrode assembly.

12. The fuel cell stack as defined in claim 10 wherein the water vapor transfer portion is defined at the first MEA end of the membrane electrode assembly and at a second MEA end of the membrane electrode assembly with the active area portion defined therebetween.

13. The fuel cell stack as defined in claim 11 wherein the active area portion is defined from a middle region of the membrane electrode assembly to the second MEA end of the membrane electrode assembly.

14. The fuel cell stack as defined in claim 10 wherein the water vapor transfer portion is defined at a second MEA end of the membrane electrode assembly and the active area portion is defined from a middle region to the second MEA end of the membrane electrode assembly.

15. The fuel cell stack as defined in claim 13 wherein the stream of hydrogen enters each fuel cell proximate to the second MEA end, and a stream of charged air enters the fuel cell proximate to the first MEA end while a first water stream passes through the water vapor transfer membrane proximate to the first MEA end and a second water stream passes through the water vapor transfer membrane proximate to the second MEA end.

16. The fuel cell stack as defined in claim 15 wherein an anode loop of the fuel cell is configured to send the water byproduct from an anode side of the fuel cell back to an anode inlet of the fuel cell proximate to the second MEA end.

17. The fuel cell stack as defined in claim 16 wherein a cathode loop of the fuel cell is configured to send the water byproduct from a cathode side of the fuel cell back to a cathode inlet of the fuel cell proximate to the first MEA end.

18. The fuel cell stack as defined in claim 16 wherein the water vapor transfer portion disposed at the first MEA end is configured to transfer moisture from a moisture rich primary stream to a secondary stream provided to the fuel cell proximate to the first MEA end.

19. The fuel cell stack as defined in claim 16 wherein the water vapor transfer portions disposed at each of the first and the second MEA ends are configured to transfer moisture from a moisture rich primary stream to a secondary stream provided to the fuel cell proximate to the first MEA end.
